(19) United States
(12) Patent Application Publication
(10) Pub. No.: US 2007/0136222 A1
(43) Pub. Date: Jun. 14, 2007

(54) Question and answer architecture for reasoning and clarifying intentions, goals, and needs from contextual clues and content

(75) Inventor: Eric J. Horvitz, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/298,408

(22) Filed: Dec. 9, 2005

(51) Int. Cl. G06N 5/00

(52) U.S. Cl. 706/45

(57) ABSTRACT

An architecture is presented that facilitates the determination of user context by employing questions and answers, and reasoning about user intentions, goals and/or needs based on contextual clues and content. A context component facilitates capture and analysis of context data and a clarification component initiates human interaction as feedback to validate determination of the user context. The context component can include a number of subsystems that facilitate capture and analysis of context data associated with the user context, for example, a portable communications device (e.g., a cell phone) can employ an image capture subsystem (e.g., a camera) that tales a picture of a context object or structure such as a sign, building, mountain, and so on. The image can then be analyzed for graphical content and text content.

### BACKGROUND

The advent of global communications networks such as the Internet has served as a catalyst for the convergence of computing power and services in portable computing devices. For example, in the recent past, portable devices such as cellular telephones and personal data assistants (PDAs) have employed separate functionality for voice communications and personal information storage, respectively. Today, these functionalities can be found in a single portable device, for example, a cell phone that employs multimodal functionality via increased computing power in hardware and software. Such devices are more commonly referred to as “smartphones.”

The Internet has also brought internationalization by bringing millions of network users into contact with one another via mobile devices (e.g., telephones), e-mail, websites, etc., some of which can provide some level of textual translation. For example, a user can select their browser to install language plug-ins which facilitate some level of textual translation from one language text to another when the user accesses a website in a foreign country. However, the world is also becoming more mobile. More and more people are traveling for business and for pleasure. This presents situations where people are now face-to-face with individuals and/or situations in a foreign country where language barriers can be a problem. With the technological advances in handheld and portable devices, there is an ongoing and increasing need to maximize the benefit of these continually emerging technologies. Given the advances in storage and computing power of such portable wireless computing devices, they now are capable of handling many types of disparate data types such as images, video clips and, audio and text data. Accordingly, a mechanism is needed whereby user experience can be enhanced by exploiting the increased computing power and capabilities of portable devices.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The invention disclosed and claimed herein, in one aspect thereof, comprises a system that facilitates the determination of user context. The system can include a context component that facilitates capture and analysis of context data to facilitate determining the user context, and a clarification component that initiates human interaction as feedback to validate determination of the user context. The context component can include a number of subsystems that facilitate capture and analysis of context data associated with the user context. For example, a portable communications device (e.g., a cell phone) can employ an image capture subsystem (e.g., a camera) that tales a picture of a context object or structure such as a sign, building, mountain, and so on. The image can then be analyzed for graphical content and text content, which can provide clues as to the user context.

In another aspect, feedback is facilitated in the format of questions and answers so as to enhance the accuracy of context determination. Additionally, the questions and answers can be generated not only in a language of a device user, but also in one or more other languages of indigenous people with whom the user is trying to communicate. The questions and answers can be in the form of text and/or speech.

In another aspect of the subject invention learning and/or reasoning can be employed to further refine and enhance user experience by quickly and accurately facilitating communications between people of different languages.

In yet another aspect thereof, the learning and reasoning component is provided that employs a probabilistic and/or statistical-based analysis to prognose or infer an action that a user desires to be automatically performed.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a system that facilitates the determination of user context in accordance with an innovative aspect.

FIG. 2 illustrates a methodology of determining user context according to an aspect.

FIG. 3 illustrates a system that employs reasoning to facilitate determination of the user context.

FIG. 4 illustrates a methodology of applying reasoning to facilitate determination of the user context in accordance with another aspect of the innovation.

FIG. 5 illustrates a methodology of applying reasoning and user clarification to facilitate determination of the user context in accordance with another aspect of the innovation.

FIG. 6 illustrates a block diagram of a system that facilitates determination of user context in accordance with an innovative aspect.

FIG. 7 illustrates a methodology of employing image content to improve on the accuracy of the architecture according to an aspect.

FIG. 8 illustrates a methodology of employing speech content to improve on the accuracy of the architecture in accordance with the disclosed innovation.

FIG. 9 illustrates a block diagram of device that can be utilized to facilitate reasoning about and clarifying intentions, goals and needs from contextual clues and content according to an innovative aspect.

FIG. 10 illustrates a methodology of utilizing GPS signals improve on the user experience in a context.

FIG. 11 illustrates a methodology of translating GPS coordinates into a medium that can be used to improve on context determination.

FIG. 12 illustrates a methodology of utilizing reasoning for selection of a language module.

FIG. 13 illustrates a methodology of applying constraints to improve the accuracy of context determination according to an aspect.

FIG. 14 illustrates a more detailed block diagram of a feedback component that employs a question-and-answer subsystem in accordance with an innovative aspect.

FIG. 15 illustrates a schematic block diagram of a portable wireless multimodal device according to one aspect of the subject innovation.

FIG. 16 illustrates a block diagram of a computer operable to execute the disclosed architecture.

FIG. 17 illustrates a schematic block diagram of an exemplary computing environment.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In a highly mobile society, users are now more free then ever to travel and explore different parts of the world. When traveling in foreign countries, the communication of intentions, goals, and locations of objects of interest to indigenous people can be problematic. However, there are mixed-initiative technologies that can be employed which facilitate clarification of these user intentions, user goals, locations of objects of interest. For example, in the context of image capture (e.g., a camera), when a picture is taken of a sign, for example, a portable system or device of the user that includes such image capture and analysis capability can be configured to prompt the user (e.g., ask via speech or prompts via text, . . . ) to provide some feedback on the type of object that was captured in the image. That is, if it is not already clear to the technology included with the device (e.g., a capturing and analysis component) what the image of the captured object shows, the system automatically queries the user to provide user feedback for confirmation as to the validity of the image with respect to the sign.

In the area of data capture and speech translation, it is also desirable to consider data about places that can provide information from the owners or users of the device and/or from the people being interacted with (e.g., indigenous people). That is, focusing, problem-reducing, constraining, and confirming so as to raise the level of accuracy and performance of the device by getting the right constraints, cues, and hints from the users or other people in an elegant manner.

There can be different special capture modes and services beyond snapping pictures. For example, GPS (global positioning system) technology can be employed to capture the coordinates of places, optionally associate the coordinates with pictures for remembering and communicating, and then convert the GPS coordinates into a foreign utterance that us common to the location. In another example, the name of the coordinate sector, subsector, etc., can be presented to a recipient in a foreign language (as well as the English translation thereof), which allows the user to help expand on the focus of attention (e.g., for GPS, “You are at these coordinates; do you wish to . . . ”). Beyond explicit use of GPS or other location signals such as Wi-Fi signals, systems can gain information about a person's context by recognizing when signals are lost. For example, GPS often is not well received inside building structures and in a variety of locations in cities, referred to as “urban canyons”—where GPS signals can be blocked by tall structures, as one example. However, information about when signals, that had been recently tracked, become lost, coupled with information that a device is still likely functioning, can provide useful evidence about the nature of the structure that is surrounding a user. For example, consider the case where the GPS signal, reported by a device carried by a user, reports an address adjacent to a restaurant, but, shortly thereafter, the GPS signal is no longer detectable. Such a loss of a GPS signal followed by the location reported by the GPS system before the signal vanished may be taken as valuable evidence that a person has entered the restaurant.

Based on at least some or all of the above, additional capabilities can be employed. For example, reasoning can be applied to facilitate clarifying the intentions, goals, and needs based on contextual clues and content. For example, processing can include saving and translating geographical coordinate data, translating the coordinate data in a location or area, and associating structures with the location or area (e.g., prompting the user to “select from these buildings”).

Thereafter, English translations can be retrieved, as well as the pictures and other content. The device then accesses a set of appropriate questions and comments in available speech utterances (e.g., English and/or foreign language) that users can speak, and/or that users can simply present (e.g., play and/or display) to indigenous people who do not have the ability to speak the language of the device.

Additionally, best guesses, based on an identified focus of attention and contextual constraints, can support the application of real-time speech-to-speech translation. Higher usable accuracies are attainable by using the device context and one or more identified concepts to create very focused grammars or language models.

Direct text conversion into speech rendered in another language, and the conversion of captured concepts into speech is desirable. The architecture can begin processing with simple approaches that do not assume any speech translation, and then proceed from capture of an item at the focus of attention to the use of simple speech translation and the use of the language models focused by the capture of the content of one or more items at the focus of attention and other context such as location. Accordingly, following is a description of systems, methodologies and alternative embodiments that implement the architecture of the subject innovation.

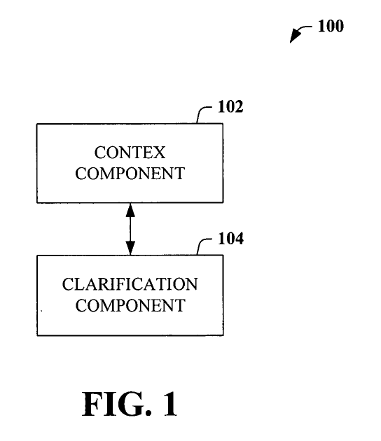

Referring initially to the drawings, FIG. 1 illustrates a system 100 that facilitates the determination of user context in accordance with an innovative aspect. The system 100 can include a context component 102 that facilitates capture and analysis of context data to determine the user context, and a clarification component 104 that initiates human interaction as feedback to validate determination of the user context. The context component 102 can include a number of subsystems that facilitate capture and analysis of context data associated with the user context. For example, a portable communications device (e.g., a cell phone) can employ an image capture subsystem (e.g., a camera) that tales a picture of a context object or structure such as a sign, building, mountain, and so on. The image can then be analyzed for graphical content and text content to extract clues as to the user context. For example, of the image is of a sign posted at the border of Wyoming that says “Welcome to Wyoming”, the device can include a recognition subsystem that can analyze the text of the image, and process it for output presentation to the device user. This processing can facilitate output presentation in the form of text data, image data, speech signals or both, for example.

In another implementation, if the text captured in the image of the sign was in a foreign language, analysis of the text can be helpful in determining the user context as well as in selecting a suitable language model for processing the foreign language and output presentation to the device user and/or a person indigenous to the user context. If analysis of the context data results in a flawed selection of the language model, the output presented my not be understandable to at least one person (e.g., an indigenous person). Accordingly, there needs to be a mechanism whereby user feedback can be received and processed to improve the accuracy of context determination process.

In furtherance thereof, the system 100 includes the clarification component 104 to solicit user feedback as to the accuracy of the presented output and/or feedback from an indigenous person where the context is in a foreign country, for example. Feedback or validation of the presented output can be implemented via a question-and answer-format, for example. Thus, if the output is presented first in the English language, given that the device user speaks and understands English, the clarification component 104 can facilitate prompting of the device user with a question in English that focuses on the derived or computed context. The prompt can also or alternatively be in a textual format that is displayed to the device user. The user can then interact with the device to affirm (or validate) or deny the accuracy of the presented output. Similarly, the question-and answer-format can be presented for interaction with an indigenous person of the user context. The device user can simply hold the device sufficiently close for perception by the person and allow interaction by the person in any number of ways such as by voice, sounds, and/or user input mechanisms of the device (e.g., a keypad).

These are only but a few of the implementations and capabilities of the disclosed architecture. For example, human interaction includes perceiving and interacting with displayed text, speech signals, image data and/or video data or content some or all of which are employed to reason about and clarify intentions, goals, and needs from contextual data that can provide clues as to the actual user context.

In another implementation, the contextual component 102 can include a geographical location subsystem that processes geographic coordinates associated with a geographic location of the user context. For example, GPS (global positioning system) can be employed to filter or constrain context data that may have been processed and/or retrieved for processing and presentation to improve the accuracy of the system 100. For example, there is no need to retrieve data associated with the Empire State Building if capture and analysis of the content data indicates that the user context is associated with GPS coordinates of a street in Cheyenne, Wyo.

In yet another implementation, the geographical coordinates can be processed and converted into speech or a language text associated with that user context. For example, if the processed context data (or clue data) indicates that the user context is France, the geographical coordinates can be processed into data representative of sector data, subsector data, etc., and the representative data output as French voice signals for audible perception by an indigenous French person or French text for reading by the same person. Once perceived, the person and/or the device user can be allowed to input feedback for clarification or confirmation of the user context.

In still another implementation, the system 100 can employ a learning and/or reasoning component that employs a probabilistic and/or statistical-based analysis to prognose or infer an action that a user desires to be automatically performed. Reasoning can be employed to further facilitate more accurate determination of the user context. Additionally, reasoning can be employed to output more accurate questions based on already received contextual information. Thereafter, learning can be employed to monitor and store user interaction (or feedback) based on the presented question. The learning and/or reasoning capabilities are described in greater detail infra.

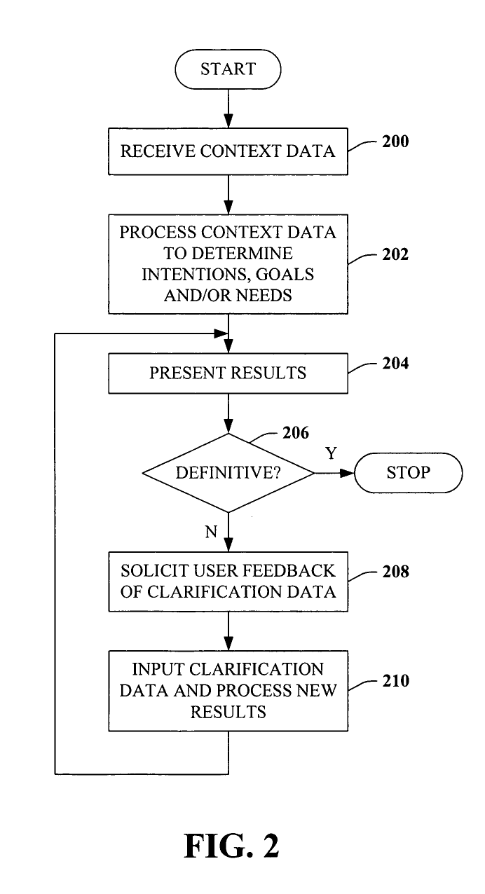

FIG. 2 illustrates a methodology of determining user context according to an aspect. While, for purposes of simplicity of explanation, the one or more methodologies shown herein, e.g., in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, context data of the user context is received. This can be by the user device including one or more subsystems that facilitate the capture and analysis of context content (e.g., images, videos, text, sounds, . . . ). At 202, the context data is processed to determine user intentions, goals and/or needs, for example. At 204, the results are presented to a user for perception. At 206, the system can solicit a user for feedback as to the definitiveness (or accuracy) of the results to the user context. If the user responds in the negative, flow is from 206 to 208 wherein the system queries (or prompts) a user for clarification data (e.g., in a question-and-answer format). At 210, the clarification data is input and processed to generate new results. Flow is then back to 204 to again present the new results to a user. This process can continue until such time as the user responds in the affirmative indicating that the results are suitably accurate of the actual user context. Flow can then be to a Stop position, although it need not be. It is within contemplation of the subject innovation that further processing can be employed to facilitate organized communicative interchange between a user and a person that speaks a different language, for example.

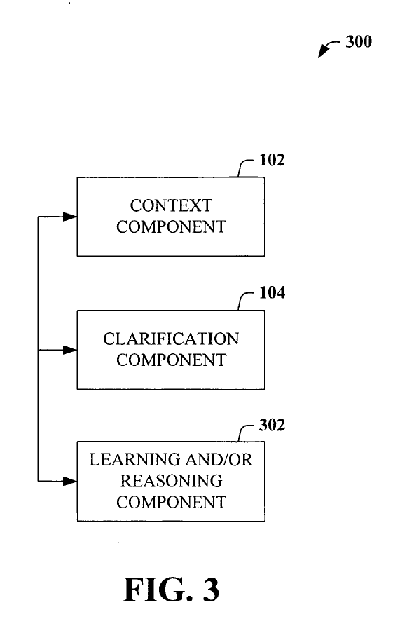

FIG. 3 illustrates a system 300 that employs reasoning to facilitate determination of the user context. The system 300 can include the context component 102 that facilitates capture and analysis of context data to determine the user context, and the clarification component 104 that initiates human interaction as feedback to validate determination of the user context. Additionally, a learning and/or reasoning component 302 can be employed to at least reason about context data captured and analyzed to improve the accuracy in the process of determining the user context. As indicated, a learning capability can also be included, although this is not required for utilization of the subject invention. Such capabilities are described in greater detail infra with respect to classifiers.

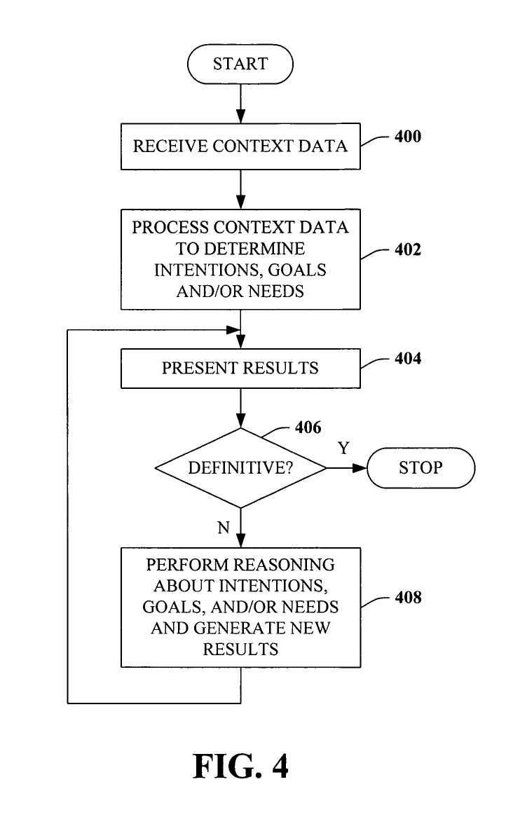

FIG. 4 illustrates a methodology of applying reasoning to facilitate determination of the user context in accordance with another aspect of the innovation. At 400, context data of the user context is received for processing. At 402, the context data is processed to determine user intentions, goals and/or needs. At 404, the associated results are presented. At 406, the system checks to see if the results are definitive of the user context. If not, flow proceeds to 408 to reason about the user intentions, goals, and/or needs, and therefrom, generates new results. Flow is then back to 404 to present the new results to a person. If the user responds affirmatively, flow exits 406 to stop. However, if the user responds negatively, flow can continue back to 408 to again apply reasoning and generate another new result for presentation to the user.

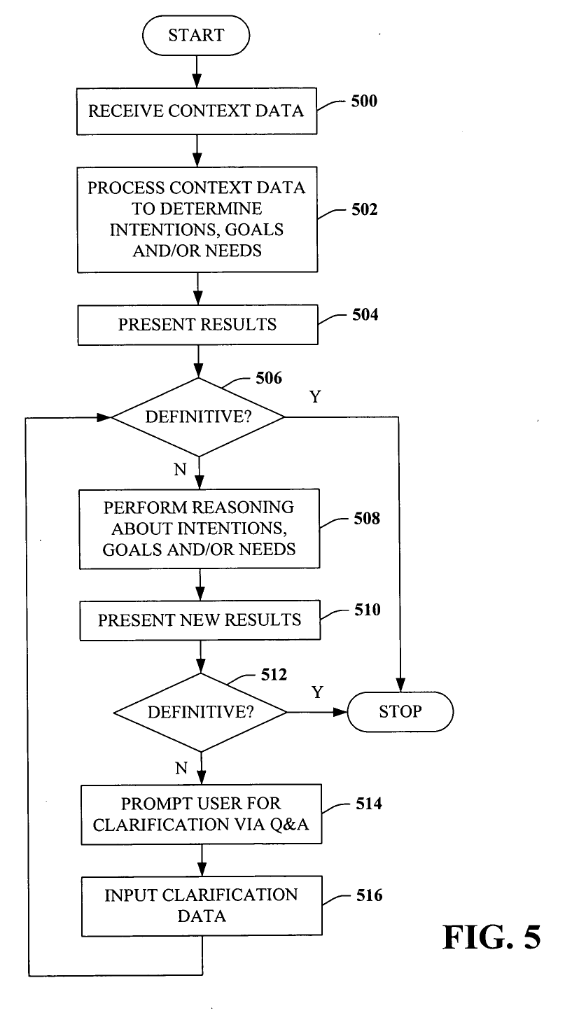

FIG. 5 illustrates a methodology of applying reasoning and user clarification to facilitate determination of the user context in accordance with another aspect of the innovation. At 500, context data of the user context is received for processing. At 502, the context data is processed to determine user intentions, goals and/or needs. At 504, the associated results are presented. At 506, the system checks to see if the results are definitive of the user context. If not, flow proceeds to 508 to reason about the user intentions, goals, and/or needs, and therefrom, generates new results. At 510, the new reasoned results are presented. At 512, the system checks to see if the new reasoned results are definitive of the user context. If not, flow proceeds to 514 to prompt the user or another user for clarification via the question-and-answer format. At 516, the clarification data is input to the process. Flow is then back to 506. If the user responds affirmatively, flow exits 506 to stop. If the context is still not definitive, such as if the user responds negatively, flow continues from 506 to 508 to again perform reasoning in view of the clarification data, and then to continue the process.

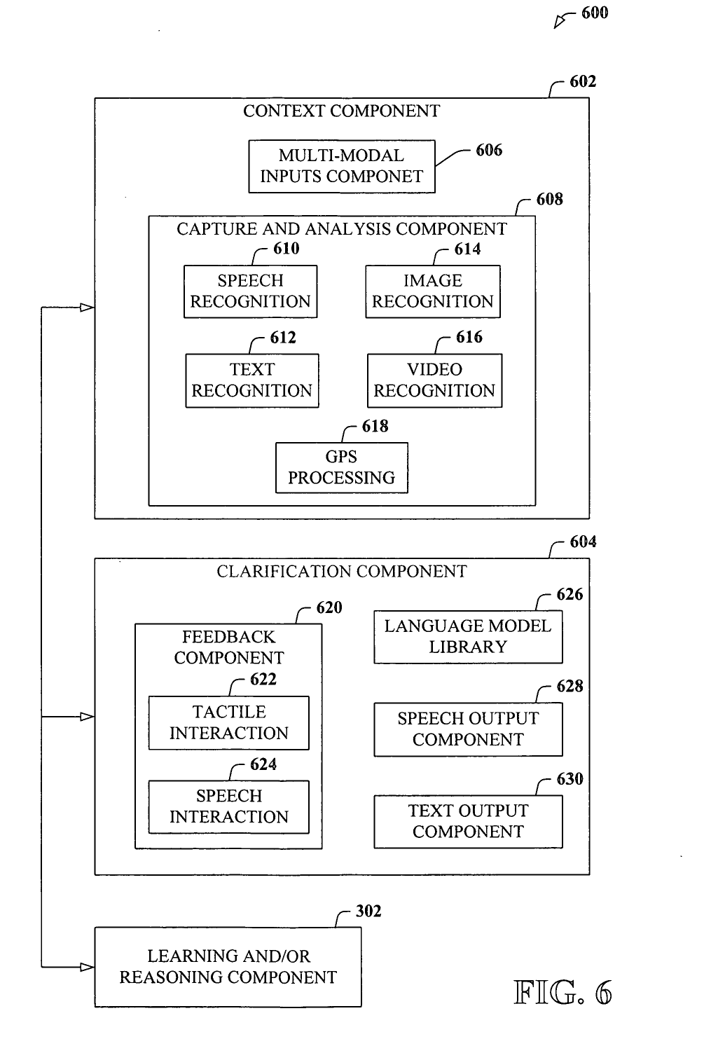

FIG. 6 illustrates a block diagram of a system 600 that facilitates determination of user context in accordance with an innovative aspect. The system 600 can include a context component 602 (similar to context component 102 of FIG. 1), a clarification component 604 (similar to context component 104 of FIG. 1), and the learning and/or reasoning component 302. In this particular implementation, the context component 602 can include a multi-modal inputs component 606 that can employ a plurality of input sensing subsystems for receiving data about the user context. For example, the sensing subsystems can include a camera for image capture, an audio subsystem for capturing audio signals, a GPS receiver for receiving GPS signals, temperature and humidity subsystems for receiving temperature and humidity data, microphone, and so on.

The context component 602 can also include a capture and analysis component 608 that interfaces to the multi-modal inputs component 606 to receive and process sensing and/or input data. For example, a speech recognition component 610 is included to process speech signals, as well as a text recognition component 612 for capturing and performing optical character recognition (OCR) on text images and/or raw text data. An image recognition component 614 operates to receive and process image data from a camera. For example, based on image analysis, guesses can be made as to structures, signs, notable places, and/or people who may be captured in the image. Similarly, a video recognition component 616 can capture and analyze video content for similar aspects, attributes and/or characteristics related to structures, signs, notable places, and/or people who may be captured in the video.

A GPS processing component 618 can process received GPS coordinates data and utilize this information to retrieve associated geographical textual information as well as image and/or video content. Thus, if the coordinates indicate that the user context is at the Great China Wall, appropriate language models can be automatically employed that facilitate interacting with people who speak the Chinese language.

The clarification component 604 facilitates human interaction (e.g., with a portable wireless device that includes the system 600) for the clarification of context data that has been derived to clarify the user's intentions, goals and/or needs. In support thereof, a feedback component 620 can be provided that facilitates human interaction by at least voice and tactile inputs (e.g., keypad, light pen, touch screen display, and other similar user input devices). Accordingly, the feedback component 620 can include a tactile interaction component 622 and a speech interaction component 624. Thus, questions can be posed to the device user and/or another person, along with answers, the purpose of which is to allow human interaction to select answers that further improve on the accuracy of the context determination process and language interaction.

A language model library 626 is employed to facilitate speech translation to the language of the user context. For example, if the device user speaks English, and the context is the Great China Wall, a language model that facilitates the translation of English to Chinese and Chinese to English, using translation in the format of text-to-text, text-to-speech, speech to text, and/or speech-to-speech can be employed. In support thereof, the clarification component 604 further includes a speech output component 628 and a text output component 630.

Additionally, the language translation or interchange between the user and an indigenous person can be accompanied by images and/or video clips related to the selected or guessed user context to further improve the context experience.

The learning and/or reasoning (LR) component 302 facilitates automating one or more features in accordance with the subject innovation. The subject invention (e.g., in connection with selection) can employ various LR-based schemes for carrying out various aspects thereof. For example, a process for determining which language model to select for a given user context can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions, including but not limited to the following exemplary implementations.

The LR component 302 can facilitate a learning process while in a user context. For example, if the user is visiting the Great Wall of China, user intentions, goal and/or needs can be adjusted or modified based on continued user interactions with the context. As the user moves through the environment taking pictures and/or videos, and interacting with indigenous people via text and/or speech translations, the LR component 302 can learn new aspects that further enhance reasoning about other aspects. Given that there can be many different dialects spoken in China, the fact that the system determines that the user context is China does not facilitate finality in the system arriving at the suitable language model. Thus, as the user travels around China, the system will continually learn and/or reason to update itself and its components based on context data and user question-and-answer interaction.

In another example, the LR component 302 can be customized for a particular user. The individual habits can be learned and further utilized to constrain processing to those aspects that are deemed more relevant to the user than to someone in general. For example, it can be learned that the user routinely travels to China in April and November, and to the Great China Wall and Shanghai. Thus, language models for these locations can be automatically employed around those time frames.

In another application, such a system can be employed in taxis in China, for example, or restaurants, or any place where foreigners or travelers are known to frequent and language barriers cause reduced context experience. Continuing with the taxi example, as the taxi changes locations in a city, GPS coordinates can be utilized to more accurately determine the taxi location. Thereafter, if it is determined that the taxi is in a French-speaking area, the system can automatically employ a French language model in preparation for French-speaking customers potentially requesting a ride. To further optimize or improve on the accuracy of the system, the cab driver can be posed with questions and answers to ensure that the proper system configuration (e.g., Chinese-French) is employed and to improve on the system for the next time that the cab and its driver and/or occupants enter this context.

Numerous other applications and automations can be realized with the LR component 302, not to limited in any way by the few examples provided herein. In another example, the LR component 302 can learn and reason about which output to employ for user interaction such as a device display, speech, text and/or images. The LR component 302 can also learn to customize the questions and answers for a particular user and context.

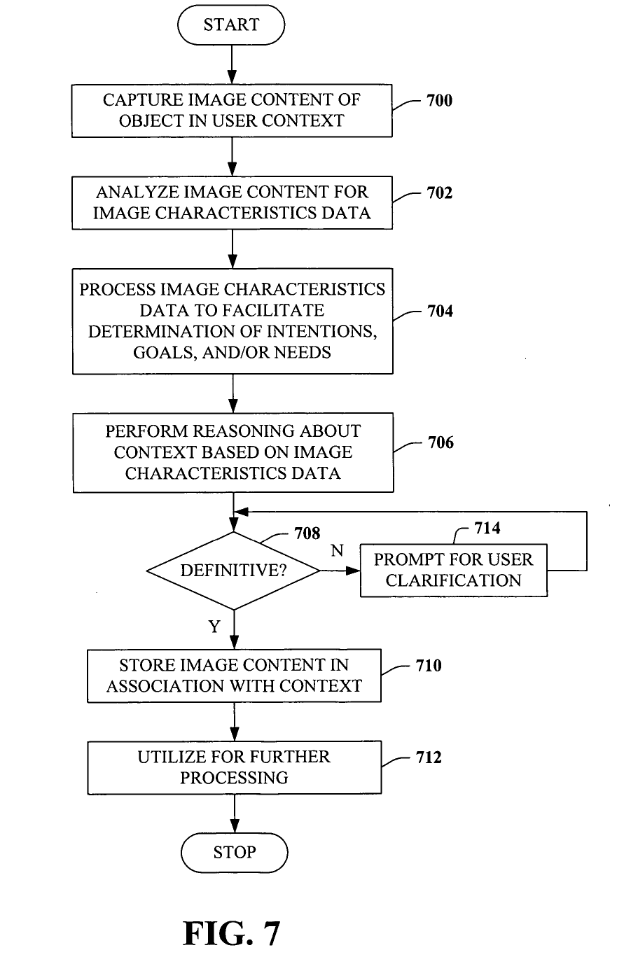

FIG. 7 illustrates a methodology of employing image content to improve on the accuracy of the architecture according to an aspect. At 700, image content is captured of an object in the user context. At 702, the image content is analyzed for image characteristics data (e.g., text, colors, notable structures, human faces, locations, . . . ). At 704, the image characteristics data is processed to facilitate determination of user intentions, goals and/or needs. At 706, reasoning is performed about the context based on the image characteristics data. At 708, the system checks if the current data is sufficient to definitively determine the user context. If so, at 710, the image content is stored in association with the context information. At 712, the stored image data can later be utilized for improving in best guesses as to user context, and other related operations. At 708, if the data is not definitive, flow is to 714 to initiate user clarification to improve system accuracy, and then back to 708 to again check for definitiveness. The output of 714 could also have been to 706 to again perform reasoning about the data given that user clarification data is now also being considered.

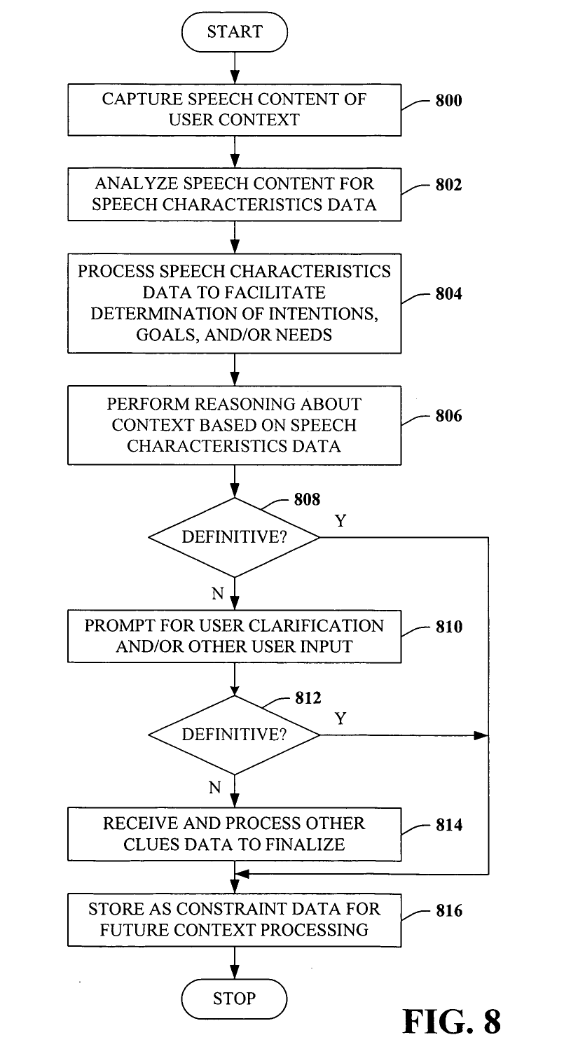

Referring now to FIG. 8, there is illustrated a methodology of employing speech content to improve on the accuracy of the architecture in accordance with the disclosed innovation. At 800, speech content is captured in the user context. At 802, the speech is analyzed for speech characteristics data (e.g., inflections, words, . . . ). At 804, the speech characteristics data is processed to facilitate determination of user intentions, goals and/or needs. At 806, reasoning is performed about the context based on the speech characteristics data. At 808, the system checks if the current data is sufficient to definitively determine the user context. If so, at 810, the speech content is stored in association with the context information. At 812, the stored speech data can later be utilized for improving in best guesses as to user context, and other related operations. At 808, if the data is not definitive, flow is to 814 to initiate user clarification to improve system accuracy, and then back to 808 to again check for definitiveness. The output of 814 could also have been to 806 to again perform reasoning about the data given that user clarification data is now also being considered.

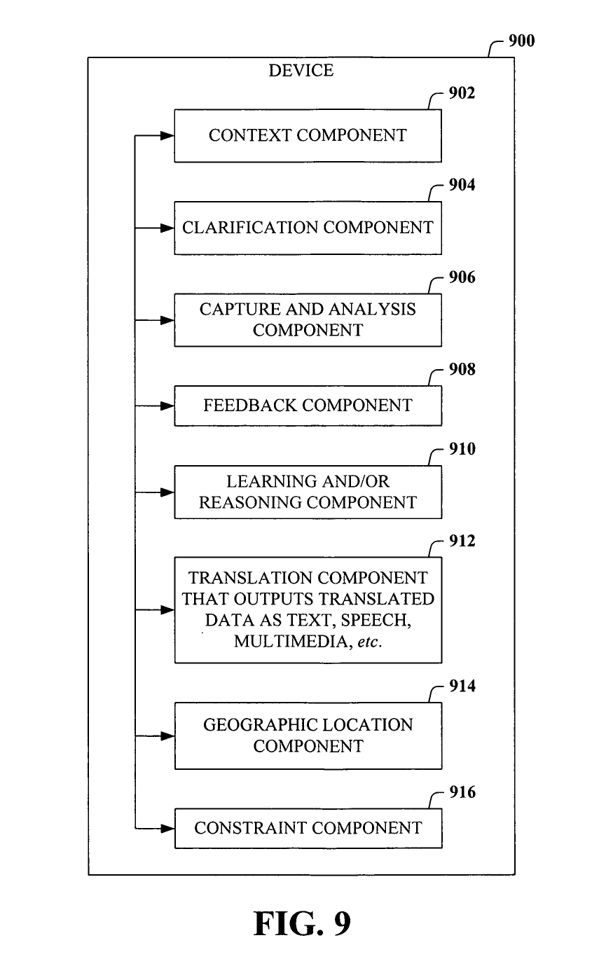

FIG. 9 illustrates a block diagram of device 900 that can be utilized to facilitate reasoning about and clarifying intentions, goals and needs from contextual clues and content according to an innovative aspect. The device 900 (e.g., a portable wireless device) can include many components some of which have been described supra in one implementation or another. For example, the device 900 can include a context component 900, a clarification component 902, a capture and analysis component 906, a feedback component 908, a learning and/or reasoning component 910, a translation component 912, a geographic location component 914 and a constraint component 916.

The constraint component 916 receives and stores information that can be utilized to limit or constrain the amount of information to be processed due to predetermined limitations such as the user and user context. For example, if the user context is determined to be in the United States, and more specifically, in a geographical area where English and a native American Navajo language is spoken based on GPS coordinates which indicate the user context, the device processing can be constrained to the appropriate language models based on, for example, the location being in the United States, the general geographic area, and so on. Such constraint processing can be performed based on rules processing of a rules engine.

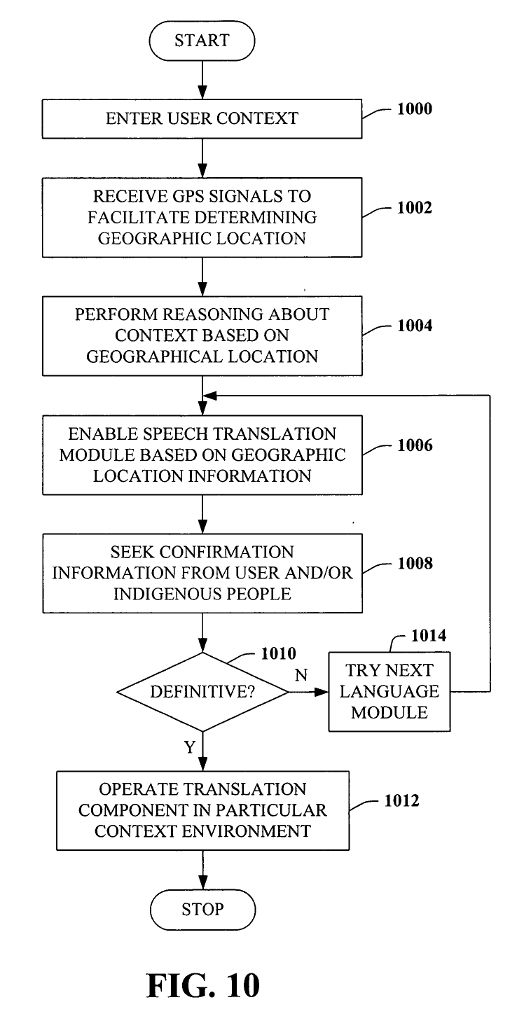

FIG. 10 illustrates a methodology of utilizing GPS signals improve on the user experience in a context. At 1000, a user enters the context. At 1002, GPS signals are received that define that approximate context location. At 1004, reasoning is performed to determine the context based on the geographical location. At 1006, a suitable speech translation model is enabled based on the GPS coordinate information. At 1008, the system initiates the question-and-answer process to receive user and/or indigenous person confirmation or clarification as to the computed context. At 1010, the system checks to determine if the computed result is definitive. If so, at 1012, the translation component is operated in the context environment for communications between the user and the indigenous people who cannot speck the language of the user. At 1010, if the computed result is not definitive, flow proceeds to 1014 where a different language module can be selected and tested. Flow then progresses back to 1006 to enable translation and seek user confirmation.

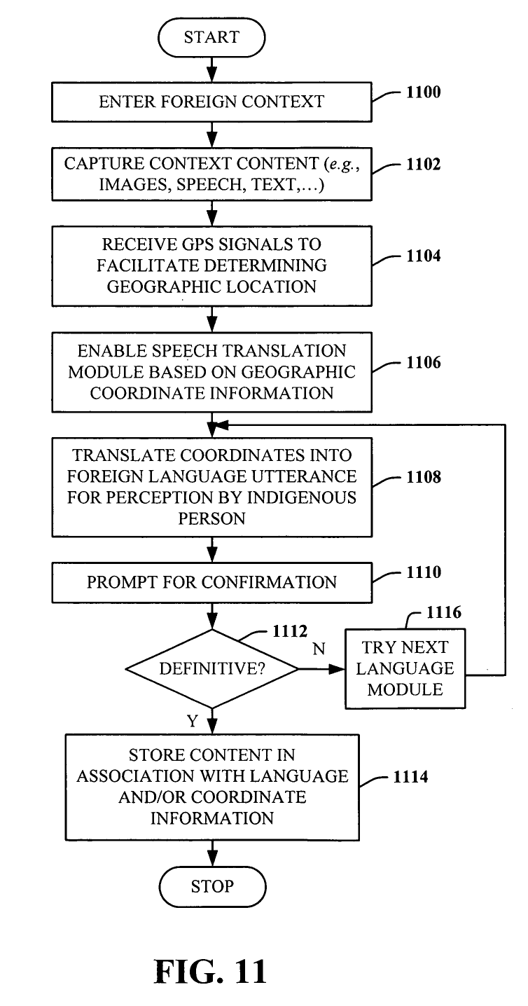

FIG. 11 illustrates a methodology of translating GPS coordinates into a medium that can be used to improve on context determination. At 1100, the user moves to a context. At 1102, context content is captured (e.g., images, speech, text, . . . ). At 1104, GPS signals are received that include geographic coordinate information. At 1106, a speech translation module is selected and enabled based on the geographic coordinate information. At 1108, the GPS coordinates are converted into a foreign language utterance that is intended to be understandable by an indigenous person. For example, the coordinates can be translated into numbers that should be understandable as speech as presented by the selected foreign language module. At 1110, the system prompts for feedback or confirmation as to the accuracy of the selected language module. Again, this can be via the question-and-answer format described supra. At 1112, the system checks to determine if the computed result is definitive. If so, at 1114, context content can be stored in association with the language module and/or location information. If the result is not definitive, flow is from 1112 to 1116 where a different language module is selected for processing and the output of information.

Note that the LR component can be employed to rank or prioritize language models (or modules) based on criteria and/or context content. For example, a French language module would be ranked lower than a German language module if the user context is Germany, although French-speaking citizens reside in Germany. In another example, different languages can be very similar in words and pronunciation. Accordingly, the LR component can reason and infer language module rankings based on these similarities.

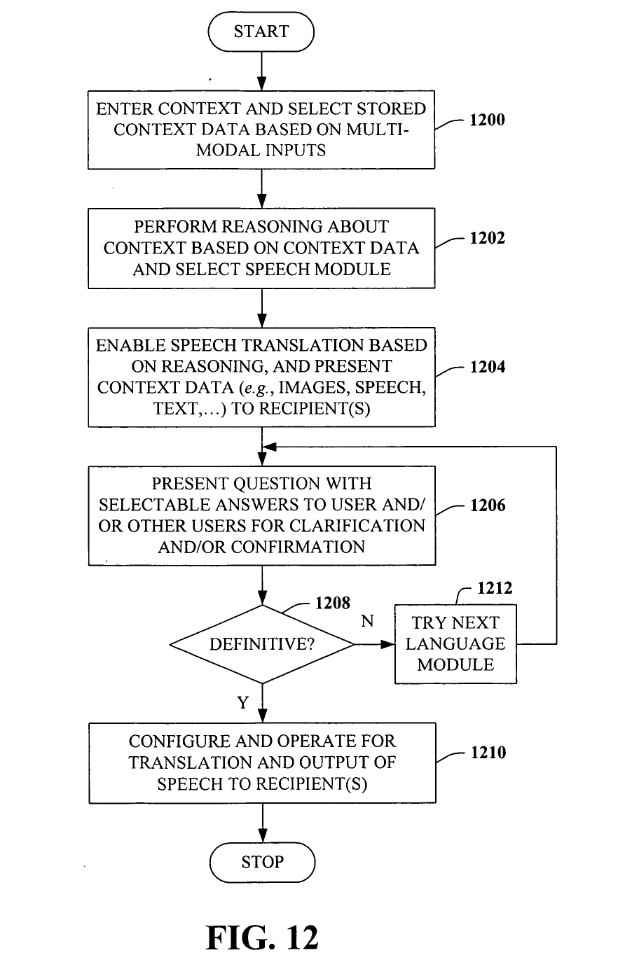

FIG. 12 illustrates a methodology of utilizing reasoning for selection of a language module. At 1200, the context is entered and stored context data is selected based on multi-modal input data. At 1202, reasoning is performed about the context based on the context data, and a speech module is selected. At 1204, speech translation is enabled based on the reasoning process, and context data (e.g., text, images, videos, voice signals, . . . ) is presented to one or more recipients. At 1206, a question is presented to one or more users, the question accompanied by selectable answers that serve to clarify and/or solicit confirmation that the context result is correct or accurate. At 1208, the system checks to determine if the computed result is definitive. If so, at 1210, a device that embodies the system is configured to operate with the selected speech translation module, and output voice signals to either or both the device user or/and other recipients. If not, flow is from 1208 to 1212 to select another language module, with flow back to 1206 to present the questions and answers in the different language, and then continue the process until the user context is determined.

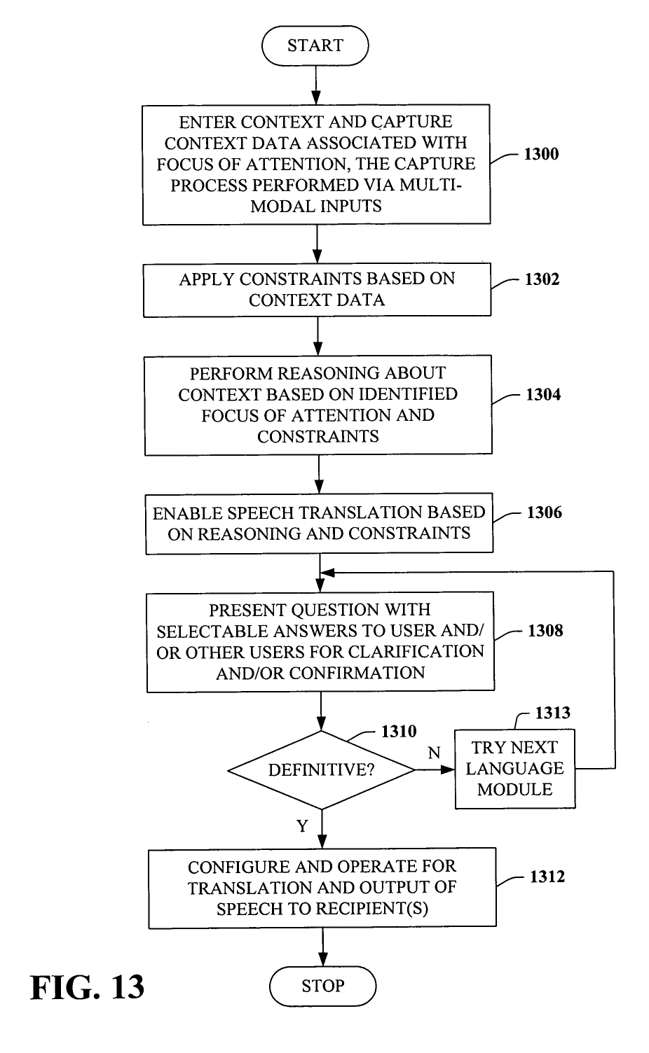

FIG. 13 illustrates a methodology of applying constraints to improve the accuracy of context determination according to an aspect. At 1300, the user brings a device into a context, or the users enter a context in which a system exists to perform the context processing. Additionally, context data is captured via one or more multi-modal inputs, the data associated with a focus of attention. At 1302, constraints are applied based on the context data. As indicated supra, the constraints can be in the form of rules which are executed after context data is received. The context data can be processed as triggers as to which rule or rules will be executed in order to constrain the processing of data to a more focused set. For example, if a multi-modal input indicates that the user context is inside a structure (e.g., a building), there would be no need to process GPS signals, since currently, such signals are not easily accessible when a receiving device is in the structure.

At 1304, reasoning is performed about the context based on an identified focus of attention and the constraints. At 1306, speech translation can be enabled based on the reasoning and constraints. At 1308, questions are presented to one or more users, the question accompanied by selectable answers that serve to clarify and/or solicit confirmation that the context result is correct or accurate. At 1310, the system checks to determine if the computed result is definitive. If so, at 1312, a device that embodies the system can be configured to operate with the selected speech translation module, and output voice signals to either or both the device user or/and other recipients. If not, flow is from 1310 to 1314 to select another language module, with flow back to 1308 to present the questions and answers in the different language, and then continue the process until the user context is determined.

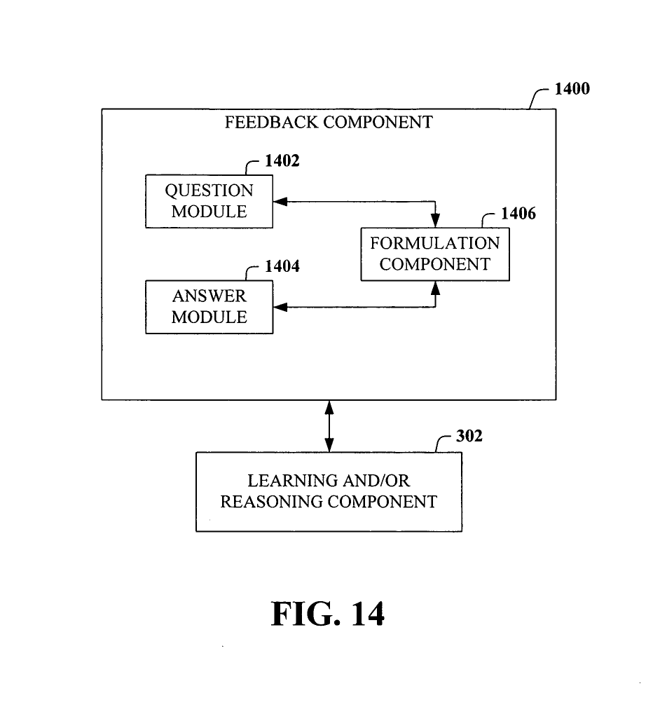

FIG. 14 illustrates a more detailed block diagram of a feedback component 1400 that employs a question-and-answer subsystem in accordance with an innovative aspect. The subsystem can include a question module 1402 that generates and provides one or more questions, an answer module 1404 that generates one o more answers based on the questions, and a formulation component 1406 that at least formats the questions and answers together for presentation to a person.

The LR component 302 can monitor the question-and-answer process and effect changes to the process based any number and type of criteria. In other words, in one example, the formatted output may receive excessive user interaction which can be inferred to mean that the output was in accurate, whereas minimal interaction can be inferred to mean that the generated or formulated output was sufficiently accurate and understandable. In any case, the LR component 302 can facilitate adjustments or modifications to questions and answers in form and content based on learned information, context information, geolocation information, any number of criteria, constraints, clues, user interactions, and so on.

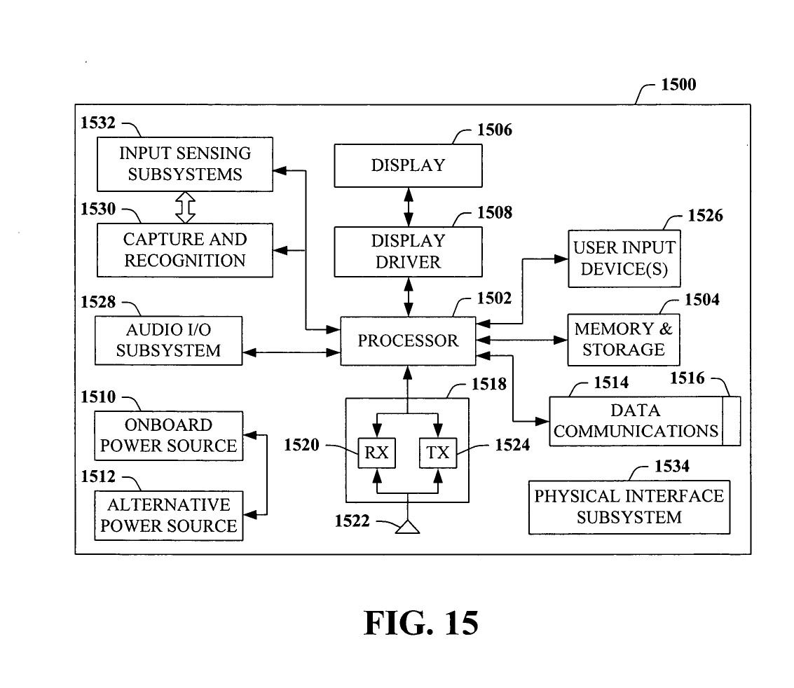

FIG. 15 illustrates a schematic block diagram of a portable wireless multimodal device 1500 according to one aspect of the subject innovation. The device 1500 includes a processor 1502 that interfaces to one or more internal components for control and processing of data and instructions. The processor 1502 can be programmed to control and operate the various components within the device 1500 in order to carry out the various functions described herein. The processor 1502 can be any of a plurality of suitable processors (e.g., a DSP-digital signal processor), and can be a multiprocessor subsystem.

A memory and storage component 1504 interfaces to the processor 1502 and serves to store program code, and also serves as a storage means for information such as data, applications, services, metadata, device states, and the like. For example, language modules and context data, user profile information, and associations between user context, images, text, speech, video files and other information can be stored here. Additionally, or alternatively, the device 1500 can operate to communicate with a remote system that can be accessed to download the language modules and other related context determination information that might be needed based on a user providing some information as to where the user may be traveling or into which contexts the user will be or typically travels. Thus, the device 1500 need only store a subset of the information that might be needed for any given context processing.

The memory and storage component 1504 can include non-volatile memory suitably adapted to store at least a complete set of the sensed data that is acquired from the sensing subsystem and/or sensors. Thus, the memory 1504 can include RAM or flash memory for high-speed access by the processor 1502 and/or a mass storage memory, e.g., a micro drive capable of storing gigabytes of data that comprises text, images, audio, and/or video content. According to one aspect, the memory 1504 has sufficient storage capacity to store multiple sets of information relating to disparate services, and the processor 1502 can include a program that facilitates alternating or cycling between various sets of information corresponding to the disparate services.

A display 1506 can be coupled to the processor 1502 via a display driver subsystem 1508. The display 1506 can be a color liquid crystal display (LCD), plasma display, touch screen display, or the like. The display 1506 functions to present data, graphics, or other information content. Additionally, the display 1506 can present a variety of functions that are user selectable and that provide control and configuration of the device 1500. In a touch screen example, the display 1506 can display touch selectable icons that facilitate user interaction for control and/or configuration.

Power can be provided to the processor 1502 and other onboard components forming the device 1500 by an onboard power system 1510 (e.g., a battery pack or fuel cell). In the event that the power system 1510 fails or becomes disconnected from the device 1500, an alternative power source 1512 can be employed to provide power to the processor 1502 and other components (e.g., sensors, image capture device, . . . ) and to charge the onboard power system 1510, if a chargeable technology. For example, the alternative power source 1512 can facilitate interface to an external a grid connection via a power converter. The processor 1502 can be configured to provide power management services to, for example, induce a sleep mode that reduces the current draw, or to initiate an orderly shutdown of the device 1500 upon detection of an anticipated power failure.

The device 1500 includes a data communication subsystem 1514 having a data communication port 1516, which port 1516 is employed to interface the device 1500 to a remote computing system, server, service, or the like. The port 1516 can include one or more serial interfaces such as a Universal Serial Bus (USB) and/or IEEE 1394 that provide serial communications capabilities. Other technologies can also be included, but are not limited to, for example, infrared communications utilizing an infrared communications port, and wireless packet communications (e.g., Bluetooth™, Wi-Fi, and Wi-Max). If a smartphone, the data communications subsystem 1514 can include SIM (subscriber identity module) data and the information necessary for cellular registration and network communications.

The device 1500 can also include a radio frequency (RF) transceiver section 1518 in operative communication with the processor 1502. The RF section 1518 includes an RF receiver 1520, which receives RF signals from a remote device or system via an antenna 1522 and can demodulate the signal to obtain digital information modulated therein. The RF section 1518 also includes an RF transmitter 1524 for transmitting information (e.g., data, service(s)) to a remote device or system, for example, in response to manual user input via a user input device 1526 (e.g., a keypad), or automatically in response to detection of entering and/or anticipation of leaving a communication range or other predetermined and programmed criteria.

The device 1500 can also include an audio I/O subsystem 1528 that is controlled by the processor 1502 and processes voice input from a microphone or similar audio input device (not shown). The audio subsystem 1528 also facilitates the presentation of audio output signals via a speaker or similar audio output device (not shown).

The device 1500 can also include a capture and recognition subsystem 1530 that facilitates the captures and processing of context data. The capture and recognition subsystem 1530 interfaces to the processor 1502, and can also interface directly to an input sensing subsystems block 1532 which can be a multi-modal system that can sense speech signals, text, images and biometrics, for example. It is to be appreciated that either/both of the capture and recognition subsystem 1530 or/and the input sensing subsystems 1532 can include individual processors to offload processing from the central processor 1502. The device 1500 can also include a physical interface subsystem 1534 that allows direct physical connection to another system (e.g., via a connector), rather than by wireless communications or cabled communications therebetween.

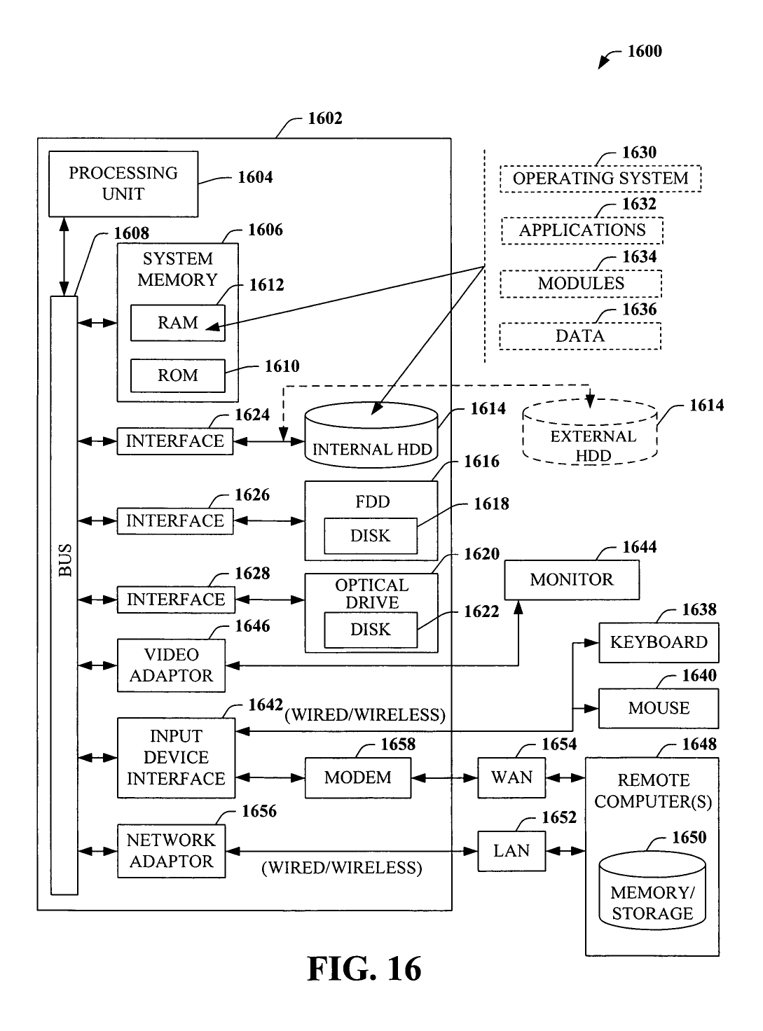

Referring now to FIG. 16, there is illustrated a block diagram of a computer operable to execute the disclosed architecture. In order to provide additional context for various aspects thereof, FIG. 16 and the following discussion are intended to provide a brief, general description of a suitable computing environment 1600 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 16, the exemplary environment 1600 for implementing various aspects includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures may also be employed as the processing unit 1604.

The system bus 1608 can be any of several types of bus structure that may further interconnect to a memory bus (with or without a memory controller), a peripheral bus, and a local bus using any of a variety of commercially available bus architectures. The system memory 1606 includes read-only memory (ROM) 1610 and random access memory (RAM) 1612. A basic input/output system (BIOS) is stored in a non-volatile memory 1610 such as ROM, EPROM, EEPROM, which BIOS contains the basic routines that help to transfer information between elements within the computer 1602, such as during start-up. The RAM 1612 can also include a high-speed RAM such as static RAM for caching data.

The computer 1602 further includes an internal hard disk drive (HDD) 1614 (e.g., EIDE, SATA), which internal hard disk drive 1614 may also be configured for external use in a suitable chassis (not shown), a magnetic floppy disk drive (FDD) 1616, (e.g., to read from or write to a removable diskette 1618) and an optical disk drive 1620, (e.g., reading a CD-ROM disk 1622 or, to read from or write to other high capacity optical media such as the DVD). The hard disk drive 1614, magnetic disk drive 1616 and optical disk drive 1620 can be connected to the system bus 1608 by a hard disk drive interface 1624, a magnetic disk drive interface 1626 and an optical drive interface 1628, respectively. The interface 1624 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. It is to be appreciated that the innovation can be implemented with various commercially available operating systems or combinations of operating systems.

A user can enter commands and information into the computer 1602 through one or more wired/wireless input devices, e.g., a keyboard 1638 and a pointing device, such as a mouse 1640. Other input devices (not shown) may include a microphone, an IR remote control, a joystick, a game pad, a stylus pen, touch screen, or the like. These and other input devices are often connected to the processing unit 1604 through an input device interface 1642 that is coupled to the system bus 1608, but can be connected by other interfaces, such as a parallel port, an IEEE 1394 serial port, a game port, a USB port, an IR interface, etc.

A monitor 1644 or other type of display device is also connected to the system bus 1608 via an interface, such as a video adapter 1646. In addition to the monitor 1644, a computer typically includes other peripheral output devices (not shown), such as speakers, printers, etc.

The computer 1602 may operate in a networked environment using logical connections via wired and/or wireless communications to one or more remote computers, such as a remote computer(s) 1648. The remote computer(s) 1648 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1650 is illustrated. The logical connections depicted include wired/wireless connectivity to a local area network (LAN) 1652 and/or larger networks, e.g., a wide area network (WAN) 1654. Such LAN and WAN networking environments are commonplace in offices and companies, and facilitate enterprise-wide computer networks, such as intranets, all of which may connect to a global communications network, e.g., the Internet.

When used in a LAN networking environment, the computer 1602 is connected to the local network 1652 through a wired and/or wireless communication network interface or adapter 1656. The adaptor 1656 may facilitate wired or wireless communication to the LAN 1652, which may also include a wireless access point disposed thereon for communicating with the wireless adaptor 1656.

When used in a WAN networking environment, the computer 1602 can include a modem 1658, or is connected to a communications server on the WAN 1654, or has other means for establishing communications over the WAN 1654, such as by way of the Internet. The modem 1658, which can be internal or external and a wired or wireless device, is connected to the system bus 1608 via the serial port interface 1642. In a networked environment, program modules depicted relative to the computer 1602, or portions thereof, can be stored in the remote memory/storage device 1650. It will be appreciated that the network connections shown are exemplary and other means of establishing a communications link between the computers can be used.

The computer 1602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

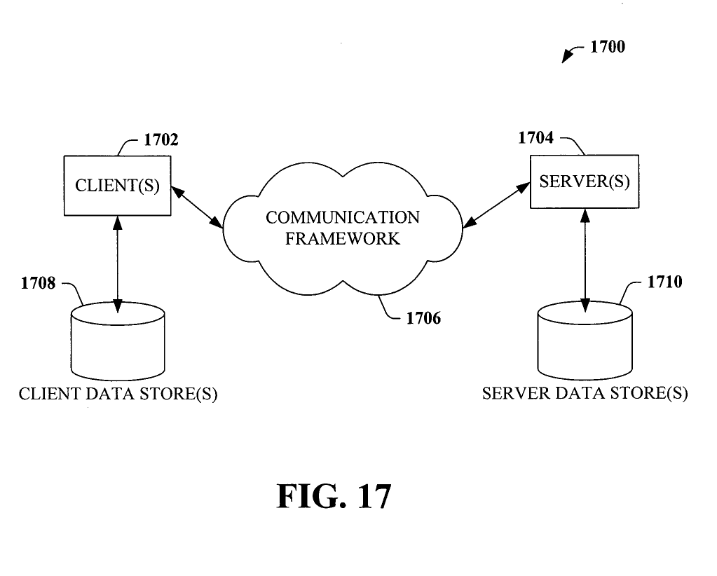

Referring now to FIG. 17, there is illustrated a schematic block diagram of an exemplary computing environment 1700 in accordance with another aspect. The system 1700 includes one or more client(s) 1702. The client(s) 1702 can be hardware and/or software (e.g., threads, processes, computing devices). The client(s) 1702 can house cookie(s) and/or associated contextual information by employing the subject innovation, for example.

The system 1700 also includes one or more server(s) 1704. The server(s) 1704 can also be hardware and/or software (e.g., threads, processes, computing devices). The servers 1704 can house threads to perform transformations by employing the invention, for example. One possible communication between a client 1702 and a server 1704 can be in the form of a data packet adapted to be transmitted between two or more computer processes. The data packet may include a cookie and/or associated contextual information, for example. The system 1700 includes a communication framework 1706 (e.g., a global communication network such as the Internet) that can be employed to facilitate communications between the client(s) 1702 and the server(s) 1704.

Communications can be facilitated via a wired (including optical fiber) and/or wireless technology. The client(s) 1702 are operatively connected to one or more client data store(s) 1708 that can be employed to store information local to the client(s) 1702 (e.g., cookie(s) and/or associated contextual information). Similarly, the server(s) 1704 are operatively connected to one or more server data store(s) 1710 that can be employed to store information local to the servers 1704.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates determination of user context, comprising:
a context component that facilitates capture and analysis of context data to determine the user context; and
a clarification component that initiates human interaction as feedback to validate determination of the user context.

2. The system of claim 1, wherein the clarification component prompts for the human interaction via a question-and-answer format.

3. The system of claim 1, wherein the human interaction includes perceiving and interacting with displayed text.

4. The system of claim 1, wherein the human interaction includes perceiving and interacting with speech signals.

5. The system of claim 1, wherein the human interaction includes perceiving and interacting with image data.

6. The system of claim 1, wherein the human interaction is via at least one of a user and an indigenous person.

7. The system of claim 1, wherein the contextual component includes a geographical location subsystem that processes geographic coordinates associated with a geographic location of the user context.

8. The system of claim 7, wherein the coordinates are processed into speech signals that are presented and understood by an indigenous person associated with the user context.

9. The system of claim 7, wherein the coordinates are processed into text that is presented and understood by an indigenous person associated with the user context.

10. The system of claim 1, wherein the clarification component facilitates translation of context data into data representative of a language that is foreign to the user context.

11. The system of claim 1, further comprising a learning and reasoning component that employs a probabilistic and/or statistical-based analysis to prognose or infer an action that a user desires to be automatically performed.

12. The system of claim 1, wherein the context component clarification component facilitates translation of context data into data representative of a language that is foreign to the user context.

13. The system of claim 1, further comprising a constraint component that constrains the context data to a focused aspect of the user context.

14. The system of claim 1, wherein the user context is associated with user intentions, goals and needs, the determination of which is further based on contextual clues and contextual content.

15. The system of claim 1, the context component and the clarification component employed in a portable wireless device.

16. A computer-implemented method of determining user context, comprising:
capturing and analyzing context data of the user context into clue data that represents a clue as to the user context;
processing the clue data to select an output data that represents user understandable information;
outputting the user understandable data to a human; and
requesting feedback from the human to validate the user context.

17. The method of claim 16, further comprising an act of outputting the user understandable data as speech data to a human who is indigenous to the user context.

18. The method of claim 16, further comprising an act of automatically selecting a language model based on the clue data, the language model facilitates output of at least one of speech and text in a language indigenous to the user context.

19. The method of claim 16, further comprising an act of constraining the context data based on GPS (global positioning system) coordinates that represent the user context.

20. A system that facilitates determination of user context, comprising:
means for capturing and analyzing context data of the user context into clue data that represents a clue as to the user context;
means for processing the clue data to select an output data that represents user understandable information;
means for outputting the user understandable data to a human;
means for presenting a question to the human as to accuracy of the user understandable information; and
means for receiving an answer to the question from the human as to the accuracy of the user context.
